(19) United States
(12) Patent Application Publication
(10) Pub. No.: US 2019/0106290 A1
(43) Pub. Date: Apr. 11, 2019

(54) SYSTEM AND METHOD FOR DISPATCHING AN ELEVATOR

(71) Applicant: Otis Elevator Company, Farmington, CT (US)

(72) Inventors: Ashley Chapman, Plainville, CT (US); Bradley Armand Scoville, Farmington, CT (US)

(21) Appl. No.: 15/750,482

(22) PCT Filed: Aug. 4, 2016
(86) PCT No.: PCT/US2016/045477

§ 371 Date: Feb. 5, 2018

Related U.S. Application Data
(60) Provisional application No. 62/201,435, filed on Aug. 5, 2015.

(51) Int. Cl. B66B 1/46

(52) U.S. Cl. CPC B66B 1/468; B66B 1/3461

(57) ABSTRACT

A system and method of dispatching an elevator car (102) in an elevator system (100) including an elevator fixture (106) in communication with at least one elevator control system (104), wherein the elevator fixture includes a fixture communication device (108) disposed therein. The method including the steps: operating a mobile device (112) to receive a travel request, operating the mobile device to transmit a travel signal (114) based on the travel request, operating the elevator fixture to receive the travel signal; and operating the elevator fixture to receive and transmit dispatch information.

### CROSS-REFERENCE TO RELATED APPLICATIONS

The present application is an international patent application, which claims priority to U.S. Provisional Patent Application Ser. No. 62/201,435, filed Aug. 5, 2015, and having the title “SYSTEM AND METHOD FOR DISPATCHING AN ELEVATOR,” which is herein incorporated in its entirety.

### TECHNICAL FIELD OF THE DISCLOSED EMBODIMENTS

The presently disclosed embodiments generally relate to the field of elevator dispatching systems.

### BACKGROUND OF THE DISCLOSED EMBODIMENTS

Modern elevator systems are essential in multi-story buildings. Ideal use of an elevator system requires efficient and convenient means of requesting and dispatching elevator service. In some instances, a passenger seeking elevator service first approaches a hall fixture located in the hallway immediately near an elevator (or a bank of elevators) and operates an elevator call button situated thereon. The hall fixture usually includes two operable call buttons-one to request an elevator for travel to upper floors, and the second to request an elevator for travel to lower floors. Upon operation, the hall fixture communicates to an elevator controller to transmit a request for elevator service. The elevator controller then dispatches an elevator to the floor from which the hall fixture was operated. After operating the call button, the passenger waits for an elevator car to arrive, without always knowing which elevator car to expect, or how long it will take for the elevator car to arrive. After the arrival of the elevator car, the passenger boards the elevator car and then selects a destination floor from an elevator car control panel housed within the elevator car.

In other instances, a passenger seeking elevator service first approaches an elevator kiosk, usually located in the hallway immediately near an elevator. The elevator kiosk has a control panel with keys for entering the destination floor and a display panel for informing passengers of the responding elevator. The passenger operates the elevator kiosk to make an elevator request that includes the desired destination floor. The elevator kiosk communicates with an elevator controller to transmit the elevator request. The elevator controller dispatches an elevator, and sends a dispatch confirmation to the elevator kiosk. The dispatch confirmation is then displayed on the elevator kiosk display panel, thereby confirming to the passenger the imminent arrival of a responding elevator car. After the arrival of the elevator car, the passenger boards the elevator car but does not have to select a destination floor since the passenger has already indicated the desired destination floor when initially operating the kiosk.

In traditional elevator call and dispatch systems, the procedure of requesting and dispatching an elevator is often slow, troublesome, and erratic. This problem is particularly exacerbated during high-traffic periods, for example, at the beginning and end of a workday in a multi-story office building. The traditional system also requires that a passenger be in the immediate vicinity of the elevator call fixture in order to be able to operate the call buttons.

Furthermore, traditional elevator call fixtures only allow for limited functional features. For example, if security based access is essential in determining access prior to granting elevator service, the traditional elevator call fixture will have to be retrofitted or otherwise upgraded to support such features. This can become expensive. Additionally, older elevator call fixtures are not easily amenable to retrofitting or upgrades.

Therefore, there is a need for an improved system and method for requesting and dispatching an elevator.

### SUMMARY OF THE DISCLOSED EMBODIMENTS

In one aspect, selected portions of an elevator system are provided. The elevator system includes an elevator fixture operably coupled to the elevator control system. In an embodiment, the elevator fixture may include at least one of a kiosk and a hall call button fixture.

In any of the previous embodiment, the elevator fixture is further configured to determine an approximate location of a mobile device and receive and validate an access authorization signal. In the previous embodiment, determining an approximate location of the mobile device includes determining a signal strength of the travel signal.

In any of the preceding embodiments, the elevator system further includes a fixture communication device disposed within the elevator fixture. The fixture communication device includes at least one of a transmitter and a receiver, and is to transmit dispatch information, and receive a travel signal from a mobile communication device and to execute at least one of a hall call and a car call in response thereto. The dispatch information includes at least one of a dispatch confirmation, car identification, and arrival time.

In one aspect, and elevator fixture is provided. The elevator fixture includes a housing, and a fixture communication device disposed within the housing, wherein the fixture communication device is configured to receive and transmit dispatch information. In an embodiment, dispatch information includes at least one of a dispatch confirmation, car identification, and arrival time. In any embodiment of the elevator fixture, the elevator fixture includes a kiosk. The communication device includes at least one of a transmitter and a receiver.

In any embodiment of the elevator fixture, the fixture communication device is further configured to determine an approximate location of a mobile device, and receive and validate an access authorization signal.

In one aspect, a method for dispatching an elevator is provided. The method includes the steps of operating a mobile device to receive a travel request, operating the mobile device to transmit a travel signal based on the travel request, operating the elevator fixture to receive the travel signal, and operating the elevator fixture to receive and transmit dispatch information. In an embodiment, operating the mobile device to receive a travel request includes operating a program stored on the mobile device to receive the travel request based in part on a selected destination floor.

In any of the preceding embodiments of the method, the method further includes operating the elevator fixture to determine an approximate location of the mobile device, wherein determining an approximate location of the mobile device includes determining a signal strength of the travel signal.

In any of the preceding embodiments of the method, operating the elevator fixture to receive and transmit dispatch information includes operating the elevator fixture to transmit the travel signal to the at least one elevator control system, and operating the at least one elevator control system to determine dispatch information. In any of the preceding embodiments, the mobile device is further configured to transmit an access authorization signal, and validate the access authorization signal.

Other embodiments are disclosed.

### BRIEF DESCRIPTION OF DRAWINGS

FIG. 1 illustrates a schematic drawing of a plurality of elevator systems; and

FIG. 2 illustrates a schematic flow diagram of a method for dispatching an elevator.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

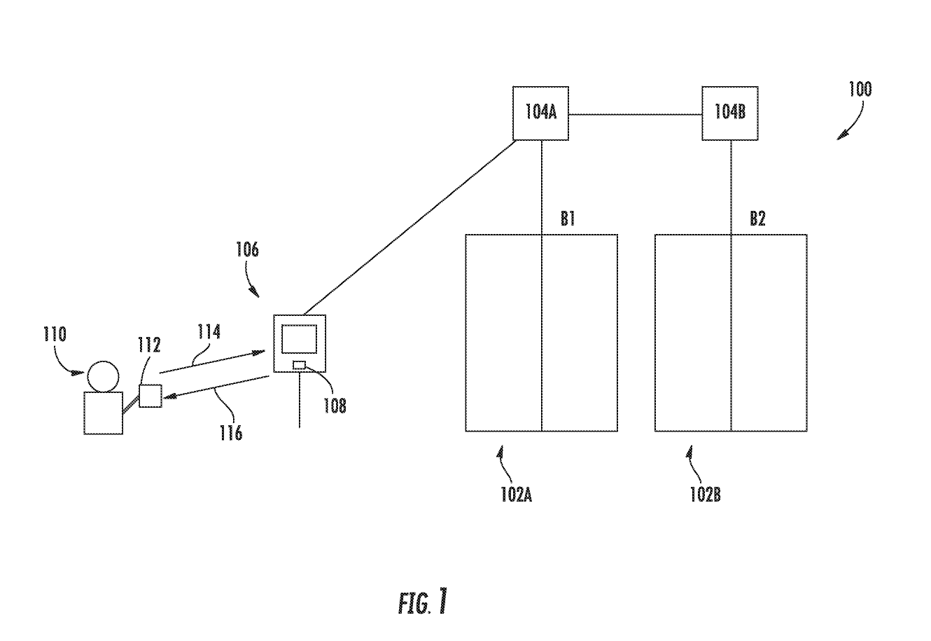

FIG. 1 illustrates a schematic drawing of a plurality of elevator systems, generally indicated at 100. The elevator systems 100 includes a plurality of elevator cars 102, wherein each elevator car 102 is in communication with an elevator control system 104. Each of the elevator control systems 104 is configured to coordinate all aspects of elevator service such as selection of elevator car, travel, speed, and accelerating, decelerating, door opening speed and delay, leveling and hall fixture signals. It will be appreciated that each of the elevator control systems 104 may be in communication with one another to coordinate aspects of each of the elevator cars 102.

The elevator systems 100 further include an elevator fixture 106 in communication with at least one of the plurality of elevator control systems 104. In at least one embodiment, the elevator fixture 106 includes at least one of an elevator kiosk and a hall call button fixture. The elevator fixture 106 is configured to request service from the elevator control system 104 at the floor in which the fixture is located.

In at least one embodiment, the elevator fixture 106 includes a fixture communication device 108 disposed therein. In an embodiment, the fixture communication device 108 includes at least one of a transmitter and a receiver. The fixture communication device 108 is configured to allow a passenger 110 to wirelessly connect to the elevator fixture 106 via a mobile device 112. For example, the fixture communication device 108 may communicate wirelessly based on the BLUETOOTH Low Energy standard (BLE standard). It will be appreciated that the elevator fixture 106 may include other short-range communication transceivers to perform the functions disclosed herein, such as Near Field Communication (NFC) to name one non-limiting example.

It will be appreciated that an elevator fixture 106 may be installed on every floor that is serviced by the elevator car 102. It will further be appreciated that the elevator fixture 106 may be installed in close proximity to the elevator cars 102.

In the present embodiment, the passenger 110 operates an application program on a mobile device 112 to request elevator service. The mobile device 112 also includes a mobile device communication device (not shown) that is configured to wirelessly communicate to the fixture communication device 108. It will be appreciated that the mobile device 112 may be any mobile device operable to perform the functions disclosed herein, for example, a mobile telephone, tablet device, or any device capable of being carried by a person outside of a home, or other structure, to name a few non-limiting examples.

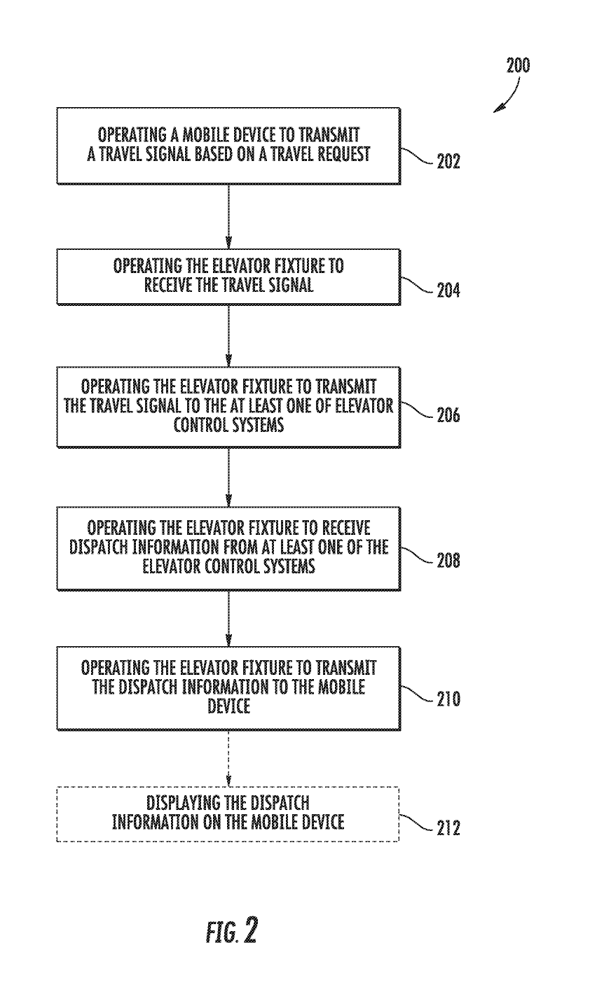

FIG. 2 illustrates a method for dispatching an elevator, generally indicated at 200. The method 200 includes step 202 of operating a mobile device 112 to transmit a travel signal 114 based on a travel request. In an embodiment, step 202 includes operating a program stored on the mobile device 112 to select a destination floor.

For example, the passenger 110 seeking elevator service approaches the elevator fixture 106. As soon as the passenger 112 is within the vicinity of the elevator fixture 106 (i.e., within communication range of the fixture communication device 108), the passenger 110 may operate a program application on the wireless device 112 to input a floor destination. Upon receiving the floor destination, the mobile device 112 transmits the travel signal 114 to the elevator fixture 106, via a mobile communication device (not shown). It will be appreciated that the passenger 110 may enter a request for elevator service prior to being in the vicinity of the elevator fixture 106.

In another embodiment, step 202 further includes operating the mobile device 112 to transmit an access authorization signal. For example, access may be restricted to a particular floor(s) at particular times of day (e.g. off-hours), or to particular elevator cars (e.g. the cargo elevator, private elevator, or handicap accessible elevator). In such cases, the passenger 110 will have to obtain access to the restricted floors based on authorization.

Consequently, the mobile device input entry system may be operated to transmit authorization information to verify a passenger's access by any means readily recognized and understood by those skilled in the art, such as, for example, entering a pin number, using a biometric scan, using a password, or using a token, to name a few non-limiting examples. In the case of unsuccessful access verification, the passenger 110 may be denied elevator service.

The method 200 further includes step 204 of operating the elevator fixture 106 to receive the travel signal 114 from the mobile device 112. For example, fixture communication device 108 is operable to receive the travel signal 114 from the mobile device 112. In another embodiment, step 206 further includes operating the elevator fixture 106 to receive the access authorization signal from the mobile device 112.

In at least one embodiment, step 204 further includes operating the elevator fixture 106 to determine an approximate location of the mobile device 112. In an embodiment, the elevator fixture 106 determines an approximate location of the mobile device 112 based at least in part on the strength of the travel signal. It will be appreciated that the location of wireless device 102 may be determined by any means readily recognized and understood by those skilled in the arts, such as, for example, using the Bluetooth Low Energy proximity detection, to name one non-limiting example.

In another embodiment, the elevator fixture 106 operates to validate the passenger's access authorization signal. It will be appreciated that the elevator fixture 106 may operate to forward the access authorization information to at least one of the elevator control systems 104.

The method 200 further includes step 206 of operating the elevator fixture 106 to transmit the travel signal 114 to the at least one of elevator control systems 104. For example, the elevator fixture 106 transmits the travel request to at least one of the elevator control systems 104. The at least one elevator control systems 104 operate to determine the location, direction of current travel, speed, etc. of the elevator cars 102 in order to determine which of the elevator cars 102 could attend to the travel request first.

The method 200 further includes step 208 of operating the elevator fixture 106 to receive dispatch information from at least one of the elevator control systems 104. In at least one embodiment, dispatch information includes at least one of confirmation of a dispatched car, car identification, and arrival time.

For example, once the elevator control systems 104A, 104B determines which elevator car 102A, 102B can service the travel request, the elevator control systems 104A, 104B send information to the elevator fixture 106 confirming that a car is being dispatched to the passenger's location, identifying which car 102 (e.g. “B1”) will attend to the request, and the approximate wait time for the car 102 to arrive.

The elevator method 200 further includes step 210 of operating the elevator fixture 106 to transmit the dispatch information to the mobile device 112. For example, as the passenger 110 continues to approach the elevator systems, and/or as the passenger 110 waits for the elevator car 102 to arrive, the fixture communication device 108 transmits the dispatch information to the mobile device via a dispatch signal 116.

In an embodiment, the method 200 further includes step 210 of the displaying the dispatch information on the mobile device 112. For example, the passenger 110 may operate the mobile device 112 to view the boarding location of the selected elevator car 102 to help the passenger 110 easily navigate to the proper location. It will be appreciated that the dispatch information may be rendered by any means readily recognized and understood by those skilled in the art, such as, for example, by visual and/or audible signals to alert the passenger 110 as to the proper elevator car 102 attended to the travel request.

It will therefore be appreciated that the elevator system 100 includes a fixture communication device 108 disposed within the elevator fixture 106 to allow a passenger 110 to quickly, and seamlessly request elevator service and receive information as to which elevator car 102 will attend to the requested service.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

1. An elevator system comprising:
an elevator control system;
an elevator fixture operably coupled to the elevator control system; and
a fixture communication device disposed within the elevator fixture, wherein the fixture communication device is configured to transmit dispatch information.

2. The elevator system of claim 1, wherein the fixture communication device comprises at least one of a transmitter and a receiver.

3. The elevator system of claim 1, wherein the elevator fixture comprises at least one of a kiosk and a hall call button fixture.

4. The elevator system of claim 1, wherein the dispatch information comprises at least one of a dispatch confirmation, car identification, and arrival time.

5. The elevator system of claim 1, wherein the fixture communication device is configured to receive a travel signal from a mobile communication device and to execute at least one of a hall call and a car call in response thereto.

6. The elevator system of claim 1, wherein the elevator fixture is further configured to determine an approximate location of the mobile device.

7. The elevator system of claim 6, wherein determining an approximate location of the mobile device comprises determining a signal strength of the travel signal.

8. The elevator system of claim 1, wherein the elevator fixture is further configured to receive and validate an access authorization signal.

9. A method for dispatching an elevator for an elevator system including an elevator fixture in communication with an elevator control system, the elevator fixture includes a fixture communication device disposed therein, and a mobile device in communication with the fixture communication device, the method comprising:
(a) operating the mobile device to receive a travel request;
(b) operating the mobile device to transmit a travel signal based on the travel request;
(c) operating the elevator fixture to receive the travel signal; and
(d) operating the elevator fixture to receive dispatch information from the elevator control system and transmit the dispatch information to the mobile device.

10. The method of claim 9, wherein step (a) comprises operating a program stored on the mobile device to receive the travel request based in part on a selected destination floor.

11. The method of claim 9, wherein step (a) further comprises operating the mobile device to transmit an access authorization signal.

12. The method of claim 9, wherein step (c) further comprises operating the elevator fixture to determine an approximate location of the mobile device.

13. The method of claim 12, wherein determining an approximate location of the mobile device comprises determining a signal strength of the travel signal.

14. The method of claim 9, wherein step (b) further comprises operating the mobile device to validate the access authorization signal.

15. The method of claim 9, wherein step (d) further comprises:
(i) operating the elevator fixture to transmit the travel signal to the at least one elevator control system; and
(ii) operating the at least one elevator control system to determine dispatch information.

16. An elevator fixture comprising:
a housing; and
a fixture communication device disposed within the housing, wherein the fixture communication device is configured to receive and transmit dispatch information.

17. The elevator fixture of claim 16, wherein the elevator fixture comprises at least one of a kiosk and a hall call button fixture.

18. The elevator fixture of claim 16, wherein the communication device comprises at least one of a transmitter and a receiver.

19. The elevator fixture of claim 16, wherein the dispatch information comprises at least one of a dispatch confirmation, car identification, and arrival time.

20. The elevator fixture of claim 16, wherein the fixture communication device is further configured to determine an approximate location of a mobile device.

21. The elevator fixture of claim 16, wherein the fixture communication device is further configured to receive and validate an access authorization signal.
